(19) United States
(12) Patent Application Publication
(10) Pub. No.: US 2012/0050532 A1
(43) Pub. Date: Mar. 1, 2012

(54) Electronic Latch and Locking Device for a Personal Locating and Tracking Device

(75) Inventor: Peter Rhyins, Prosper, TX (US)

(73) Assignee: PARAGON GPS, INC., Dallas, TX (US)

(21) Appl. No.: 12/871,763

(22) Filed: Aug. 30, 2010

(51) Int. Cl. H04N 7/18; G05B 23/02; H04W 24/00; G01S 19/51; G01S 19/42

(52) U.S. Cl. 348/143; 342/357.34; 342/357.25; 348/151; 455/456.1; 340/3.1; 348/E07.085

(57) ABSTRACT

A wearable personal tracking device that can communicate over a cellular network. The device includes a wrist mounted part, having a wristband and a clasp which holds the wristband on to the wrist of a user. The band is remotely lockable, and also creates an alarm when opened while in a specified mode. The housing holds a position detecting part which detects the position of a user who is wearing said wrist mounted part, and a cellular transceiving part which communicates information including said information via the cellular network, e.g., via G3 cellular internet connectivity. The remote monitoring node can receive the latch alarm, and can also create a remote locking command, based on conditions.

### BACKGROUND

Location detecting devices are often made to be affixed to a wearer. For example, child detection devices rely on remaining affixed to the child. If the child or a would-be abductor removes the device, it will no longer serve its purpose.

Numerous prior attempts of location systems and locking devices to affix them to the wearer have been provided in the prior art. Prior attempts for a personal tracking device to communicate with a location positioning system have led to failure of these devices in useful global situations.

U.S. Pat. No. 6,362,778 B2 describe a system able to locate and track a user retaining a portable locator unit using numerous location technologies including Global Positioning Satellite (GPS) System and the generation of a beacon for use in pinpointing the location of the locator unit and thus the user

U.S. Pat. No. 6,388,612 B2 relates to global position tracking device with a securing method to an object or person and communicating with centralized tracking systems. The device incorporates a specific code for the tracking device, and the access code is used to send signals through both methods of telephone communication and an electronic message via an Internet connection. The cellular position tracking device incorporates a rigid hinged watch band and prong clasp.

U.S. Pat. No. 6,774,799 describes a house arrest transmitter and ankle bracelet system used by law enforcement whereby the wearer has an ankle bracelet that is attached to the person by tamper-proof methods. The device communicates with a base station placed in the wearer's home or on his belt when away from home. The base station transmits a signal using land line telephone transmission and belt mounted device transmits GPS satellite communications of the wearer's position using wireless signals transmission from the ankle bracelet to the base/belt device and an alarm is sent if the ankle bracelet is tampered with or removed.

### SUMMARY

The present invention relates to a wearable location tracking device that is worn on a user's wrist, ankle or other body part, and a locking mechanism for that device.

In an embodiment, the locking mechanism device is a self contained electro-mechanical assembly that can communicate with a host tracking and monitoring devices.

One embodiment describes an alarm that is triggered when the clasp is opened and a special clasp system. An embodiment relays images and voice distress signals in the event of an alarm condition transmitted from the locking device.

### BRIEF DESCRIPTION OF THE DRAWINGS

In the Drawings:

FIG. 1A-1C shows the mechanical structure of the GPS and cellular watch according to an embodiment;

FIG. 2 shows a flow diagram of the information according to an embodiment;

FIG. 3 shows a communication flow diagram;

FIG. 4 shows a schematic of a circuit diagram of the electronic structure within the GPS locator watch.

FIGS. 5A and 5B shows a detail of the lock and latch components, with the watch clasp in the open position; and

FIGS. 6A and 6B shows a detail of the lock and latch components, with the watch clasp in the closed position.

### DETAILED DESCRIPTION

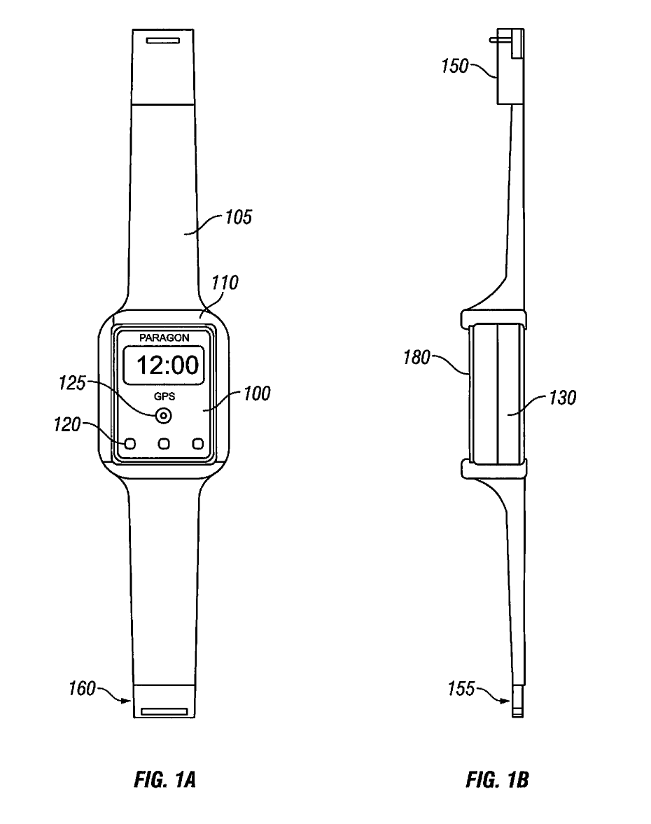

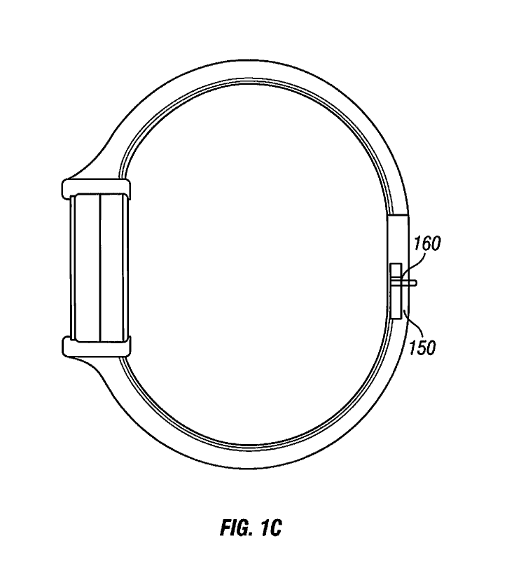

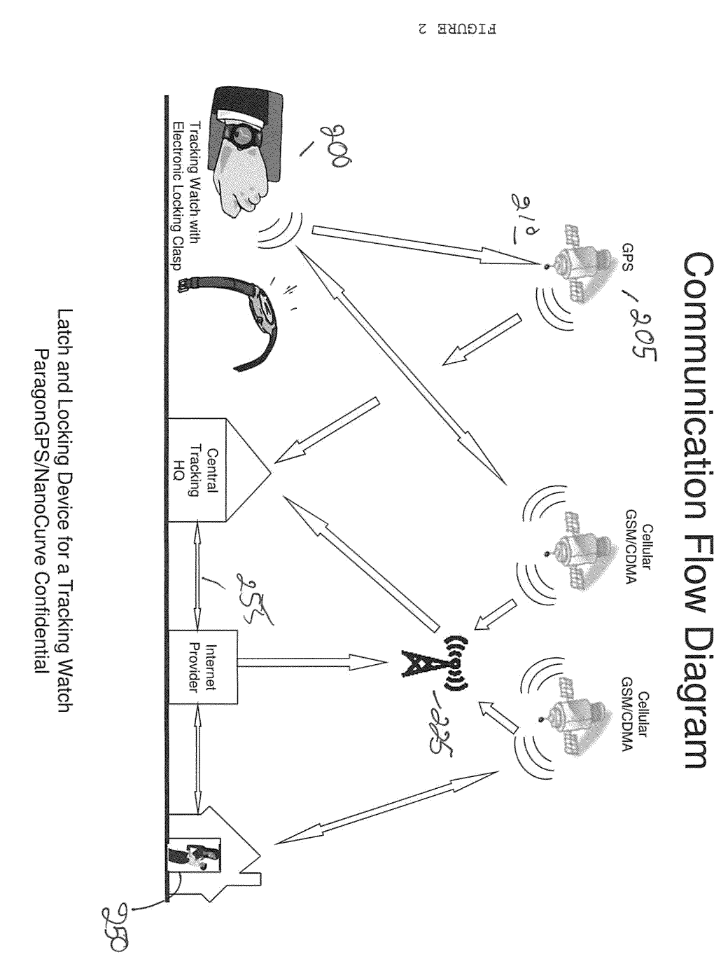

A wearable device that is worn on a person's wrist and the device having an appearance of a conventional wrist watch is used according to an embodiment. The electronic latching and lock mechanism can be used on humans, animals or pets. FIGS. 1A-1C shows the structure of the watch. The watch includes, as conventional, a bezel 100 and band 105. The bezel covers a case 110 that includes the electronic components therein. The electronic components operate as described herein to relay the wearer's position to a remote monitoring device or station as described in detail herein. For example, in one embodiment the system may incorporates a cellular telephone transmitter and receiver using G3 Internet protocol, as well as GPS receiver and transmitter. The device can transmit data that represents the location of the watch, and hence its wearer at any time. This can be done in real-time as seen by the remote monitoring device.

The watch face also includes settings buttons 120 that allows setting of different features such as the time. The watch face may also house the opening of a camera 125.

FIG. 1B shows a view of the watch from its side view, showing the case 110 holding the electronics module, and a battery 130. The clasp for the watch is formed by an electronic lock 150 that locks to a corresponding locking part 155.

The lock includes a latch portion 160 that locks to the electronic lock 150 to maintain the device on for example a child's arm. FIG. 1C shows the device as latched, where the latch device 160 extends upward into a cavity within the electronic lock portion 150.

The wearable location tracking device of the embodiment is worn on a user's ambulatory extremities. As described herein, a system is used that can track the position of the device using a combination of GPS positioning satellite system beacon and modern G3 and G4 cellular network position tracking capabilities. The locking mechanism device is a self contained electro-mechanical assembly that can communicate with the host tracking and monitoring devices. In addition, the present device incorporates methods to relay images and voice distress signals in the event of an alarm condition transmitted from the locking device through the personal tracking device.

The position of the device and wearer can be determined as shown in the communication flow diagram of FIG. 2. In a first technique, a person is wearing a tracking watch with electronically locking clasp 200. The location is determined via GPS data 210 from a GPS Satellite 205 sent to the locator watch on the person being monitored 200. A second way of determining the location is by tracking the device with G3 mobile communications and triangulation from multiple cellular, PCS, or mobile phone service transmitting towers 225, 226. Either or both of these can be used together, in order to provide a more thorough and complete coverage of the device and wearer's location. For example, this may provide improved location capability in areas such as within buildings where GPS satellite coverage is not sufficient to provide useful location information, whereas the G3 mobile communication triangulation will be used to determine the wearer's position.

In an embodiment, the device is placed into a monitoring mode. The electronic lock mechanism that is contained in the personal locating and tracking device is activated by a host monitoring cellular telephone device or computer that is connected to the Internet. The electronic lock is automatically activated when the clasp that retains the device to the wearers wrist or leg is tampered with or attempted to be removed from the wearer after an initial electronic signal has been sent to communicate to the personal locating and tracking device, or if the device or wearer's position is beyond a pre-determined area designated by the monitoring device. The watchband clasp can also be used as a ‘Panic Button’ by the wearer to send a distress signal to the monitoring device by attempting to depress the mechanical release button.

The information indicative of location is then interpreted by the remote device and compared to a perimeter around a position that is also set. The remote device user can set a pre-determined perimeter or boundary around the known location of the wearer of the device as one option, or a predetermined perimeter can be used as a default by the monitoring system.

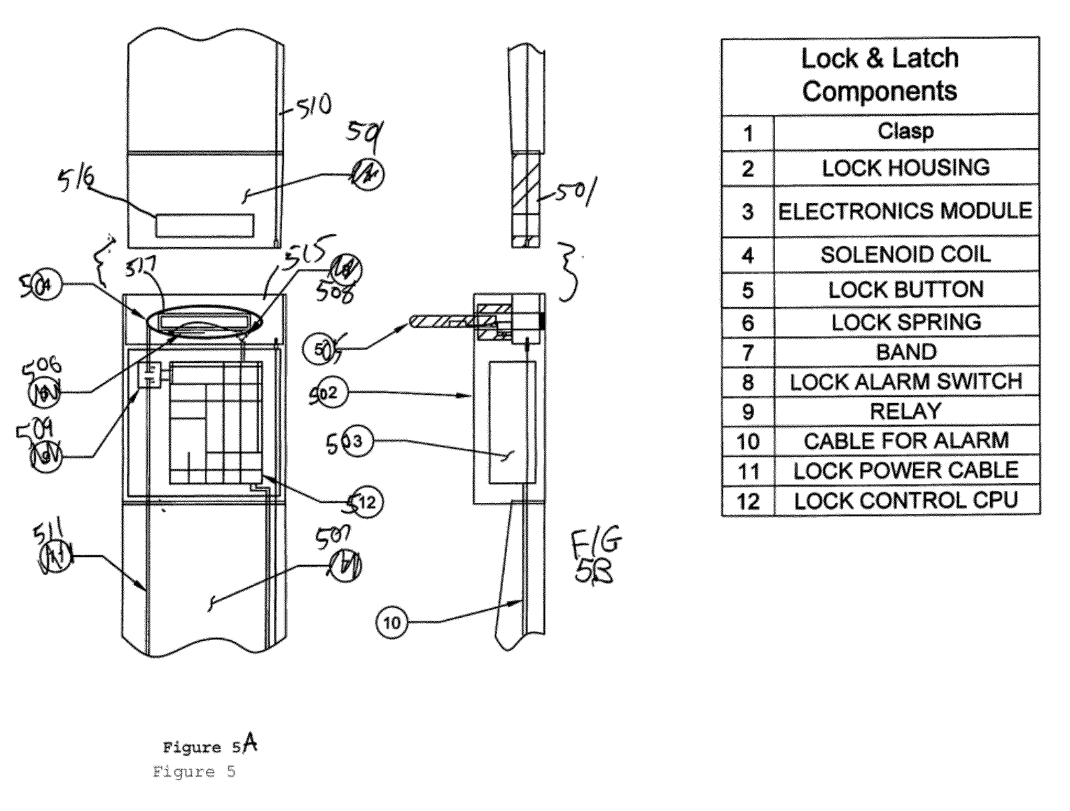

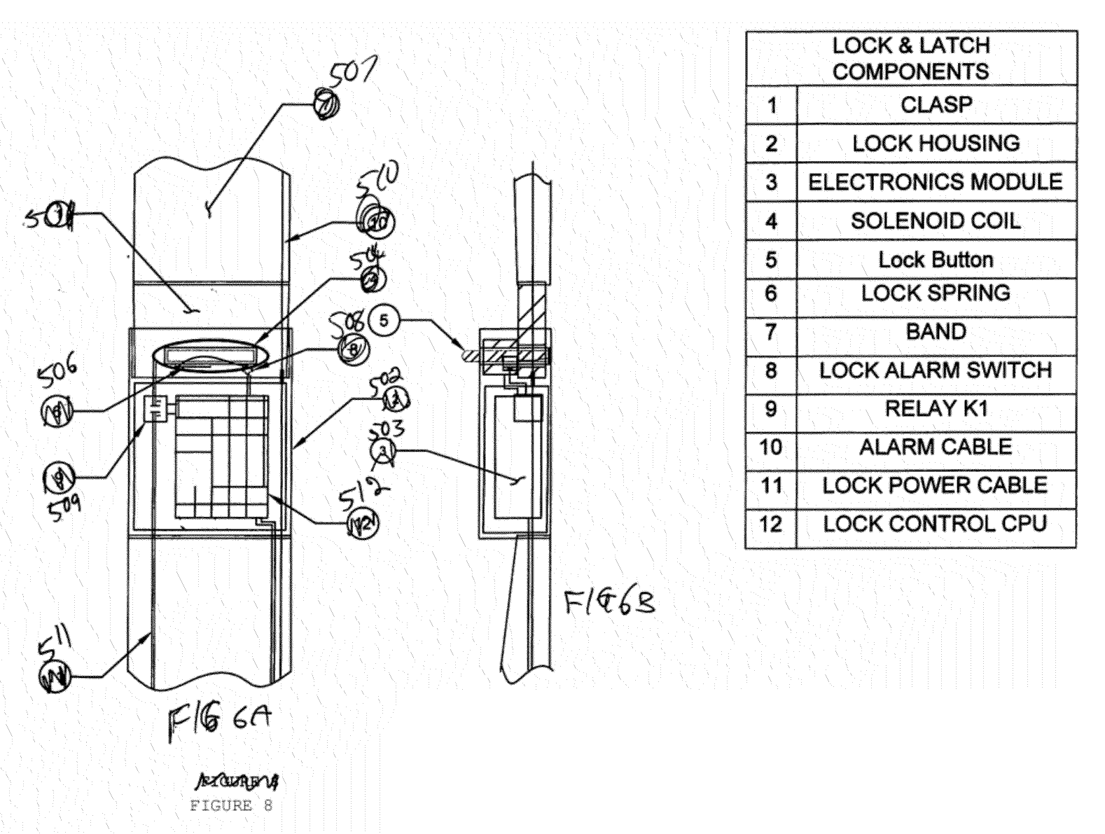

Another alarm is set if the latch detects any attempt to remove the device while on the user's wrist. Either alarm activates the electronic latch as described above. FIGS. 5A and 5B and 6A/6 the show the lock and latch components of the electronic latch. FIGS. 5A and 5B show the electronic latch in the open position. This includes the class DI which can connect to and removed from its mating part 515. In this embodiment, the clasp 501 has a first mechanical interlocking part 516 e.g. in extending part, that mates with a corresponding part 517 on the mating part 515. Once mated, the two parts are locked together by a lock spring 506. A solenoid coil 504 may hold the parts together and releasably hold the these parts as necessary using the relay 509. The lock alarm switch 500 a open is to create an indication that the latch has been opened. All of this can be done under control of the lock controlling CPU 512.

In one embodiment, there is a wire 510 that passes through the watch band 507, and conducts a small current from one side of the watch face to the other. If the wiring in the band is broken or cut, an alarm is caused, which is sent via the communications circuit. This might happen, for example, as might happen if the watchband were cut from the wearer's wrist while the latch mechanism was in the monitoring mode. The alarm is also activated if the latch button is depressed by a person attempting to separate the latch to remove the watch from the wearers wrist, unknowingly triggering both the electronic lock and alarm at the same time. A typical scenario might be a kidnapper would try and remove the watch by first depressing the button, sending the alarm and locking it onto the wrist of a child, then making another attempt to remove the watch by cutting the band, which then send another alarm that it has been removed. At that point the monitoring person (s) would know the scenario that the watch is now separated from the wearer, and the tracking ability may be lost, but the last position of the wearer would be known.

other wires 511 may carry power for the processing unit.

FIG. 5B shows a side view with the different parts and how they connect. FIG. 5B also shows a side view of the lock thousand 500 to as well as showing the lock button 505 which is depressed to open or close the law. The electronics module 503 is held within the circuit.

FIG. 6A and 6B show the same latch parts in the closed position, showing the same parts with similar role similar numerical designations.

A host cellular telephone device or computer 250 that is connected to the Internet 255 can remotely control and/or communicate with the locating device over any Internet connection.

In embodiments, the signals are sent to the monitoring device through the Internet and/or cellular service text messaging.

The locking device itself 150/155 is an electro-mechanical device which has a mechanical latch that is engaged by a small button, spring and latch mechanism 11. Once the button is depressed, the lock is physically locked to the mechanical counterpart of the wrist band, leg bracelet or necklace mechanism. An electrical solenoid retains the locked position to maintain the latch of the device to the wearer once activated remotely or triggered by the wearer. The electrical power supply for the electronic locking device is supplied through the host personal tracking device's battery 130 which powers the watch, the tracker and the communication. In one embodiment, the electronic locking mechanism's power is supplied from a second battery contained in the host watch. That second battery is one which is dedicated to support the locking mechanism only after an alarm condition is sent, and is not the same battery that is used to supply power for the watch electronics and communications. This is done to provide reserve power for the lock and to use only when needed, and not rely on the main battery source which is used continuously for communications, and that can still be used after the latch is activated or removed and perhaps drained from extended time alarm conditions, as the main use of battery power will be from the electronic lock, not from the watch or its communications.

The electronic solenoid can be locally controlled. In one embodiment, the electronic solenoid operates to retain the locked position only when an alarm signal is present. In that mode, the mechanical lock can only be released after an electronic signal is supplied through the host personal tracking device communications electronics.

When the electronic lock is activated, a signal is sent to the monitoring device through the Internet and/or cellular service text messaging. The locking device contains a camera that can relay pictures to the monitoring device when the electronic lock is activated. This information can be helpful to determine the current emergency conditions of the wearer, e.g., for law enforcement who is later looking for the wearer.

The camera 125 can be a miniature camera that transmits digital pictures. In one embodiment, this camera can be concealed and embedded into the watch housing and/or wrist band or ankle bracelet. The camera can be activated by triggering the watchband clasp. Alternatively, the camera can be remotely operated by the remote controlling device through the internet web site or connection. The camera activation transmits digital picture files to the remote device at periodic intervals, such as 10 second intervals. This 10 second interval may represent a period set by the remote activating user to minimize battery usage and data file size.

The position of the locating device is also transmitted to the remote web site/monitoring station. This is transmitted in such a manner that it will be received and interpreted through the monitoring software and relayed to an Internet web site or other remote monitoring devices. This allows the information to be seen and assessed for emergency conditions. Such transmission of information is pre-determined by the remote device configuration to send the status of the electronic latch and locking mechanism through emergency text messages or alerts to authorities, or concerned persons, as specified by the user.

In an embodiment, a robust mechanical housing and attachment is made of high strength steel and composite material that is resistant to disconnections using ordinary tools or equipment. The watch band can be a security cut resistant steel strap. The entire band can be formed of this kind of steel, or alternatively, there can be an inner strip portion formed of security steel. In an embodiment, the band 105 is constructed of high strength woven steel fiber and Kevlar material and laminated in a flexible plastic high strength ABS polymer material that is resistant to tamper, breakage, cutting, or slicing in attempting to remove the device.

The locating wristwatch device has a conventional clasp on the watchband that can be adjusted to fit different sizes of wearers.

The watchband clasp contains a switch that transmits an electronic signal to the electronic lock mechanism. The electronic lock, once activated, latches to prevent removal of the locating device from the wearer's wrist. If the clasp is forced open at that time, it causes an alarm to be established and sent over the internet connection to the monitoring host 250.

Since attempting to remove the watchband clasp causes an alarm, it inherently operates as a ‘Panic Button’ by the wearer to send a distress signal to the monitoring host 250.

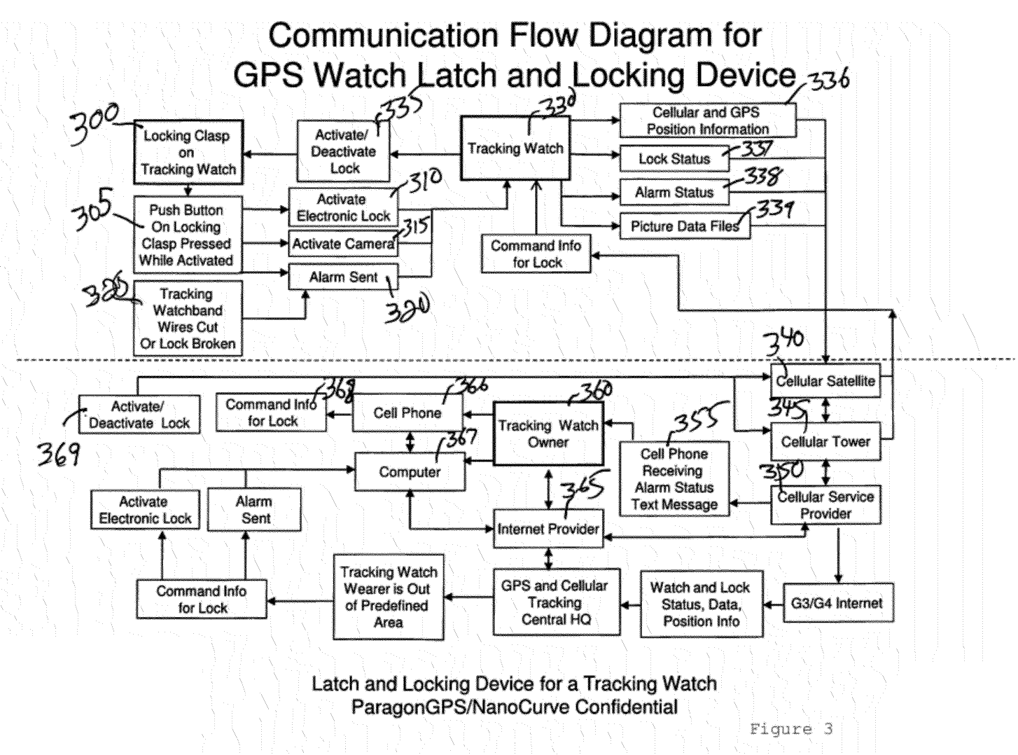

FIG. 3 illustrates a communication flow diagram of an embodiment. FIG. 3 shows at 300 a locking clasp on a tracking watch. The user pushes a button on the locking clasp at 305. This causes an activation of the electronic lock at 310 and activates the camera at 315. Also, if the device is in monitoring mode at that point, an alarm is sent at 320. Also, if the watchband or wires have been caught or the lock is broken while in this monitoring mode the alarm is also sent to 320.

All of this is sent to the tracking watch at 330. This activates the lock at 335. The tracking watch at 330 also sends cellular and GPS position, lock status, alarm status and picture data files at 336, 337, 338, 339. This is sent to the cellular satellite 340 to the cell tower 345, and/or to the cellular service provider. The service provider at 350 sends status text messages at 355. This is sent to the owner at 360 via the internet provider 365. This can be communicated by cell phone 366 or computer 367. This can send command information for the lock 368. The lock can also be activated at 369.

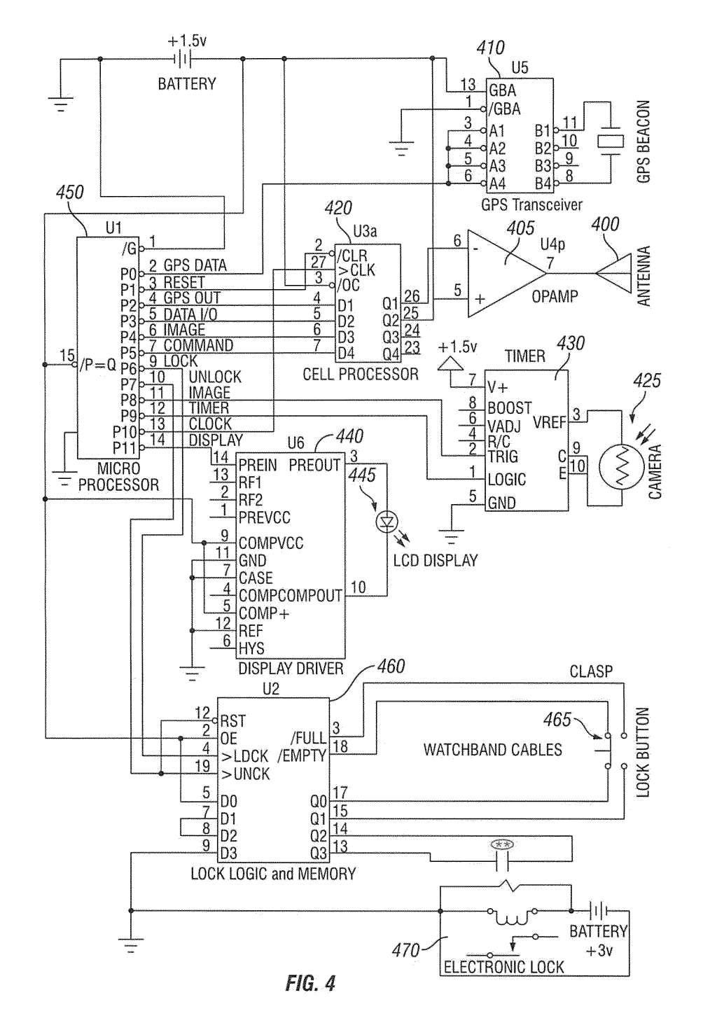

FIG. 4 illustrates an embodiment, showing the different circuitry that can be used for the watch. The watch may have an antenna 400, driven by an amplifier 405. There can also be a GPS transceiver 410 which receives the GPS information. A cell processor 420 can allow the different communication over the cellular network. A camera 425 can also be activated as described herein, and can take pictures as necessary. The camera may be driven by a timer 430 to automatically cause the camera to take pictures at various intervals. A display driver IC 440 drives a display 445. The processor 450 may carry out the various housekeeping operations.

A lock processor 460 can be a generalized IC that monitors a switch 465 associated with the lock mechanism. The switch may be in one position as shown when locked, and may be in the other position when unlocked. The IC detects the lock/unlock, to create a warning when in the device is tampered with. In addition, the lock can be electrically actuated at 470 by a relay based on a command sent over the cellular system, as previously described.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other functions may be controllable from this watch.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, display port, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein. patent

What is claimed is:

1. A latch and locking device, comprising:
a band, sized to be worn about a limb of a user;
an electro-mechanical latch retaining device, holding said band on said user wrist, said retaining device having a mechanical locking mechanism with spring loaded push-button that releases the retaining device, an electrical switch that produces an electrical state indicative of whether said locking mechanism is opened or closed, and said latch retaining device also having an electronic locking mechanism that is activated based on an electrical signal;
a housing, held on said band;
an electronic assembly, located in said housing, said electronic assembly, communicating information to a remote device; said electronic assembly coupled electrically to said mechanical latch retaining device, and receiving said electrical state indicative of whether said locking mechanism is opened or closed, producing an output signal which controls said electronic locking mechanism, said electronic assembly having a position sensor, detecting its position, sending information to said remote device indicative of whether said position is outside of a specified parameter, and information indicative of whether said latch is opened or closed, and information indicative of whether said push-button has been pressed, and receiving information from said remote device indicative of a command to lock said electronic locking mechanism.

2. A device as in claim 1, further comprising, a camera, coupled to said housing, said camera operable to obtain visual digital pictures and transmitting data indicative thereof to the remote monitoring device through wireless communications and internet via said electronic assembly.

3. The device as in claim 1, wherein said electronic assembly creates an alarm when said push button is pressed, to create a ‘Panic Button’.

4. The device as in claim 1, wherein said position sensor includes a satellite positioning system, and also includes mobile phone G3 and G4 satellite wireless communications device that transmits the position of the locating device and wearer's position through continuous, real-time location monitoring at any time to the remote monitoring device.

5. The device as in claim 4, wherein said position is obtained by GPS.

6. The device as in claim 4, wherein said position is obtained by mobile phone G3 and G4 triangulation of wireless signals from the locating device.

7. The device as in claim 4, wherein said electronic assembly automatically causes locking when no positioning signals are received.

8. The device as in claim 2, wherein said camera is concealed.

9. The device as in claim 2, wherein said camera is activated by triggering, and responsive to said triggering to transmit digital picture files to the remote device at periodic intervals.

10. The device as in claim 1 wherein said band is constructed of high strength woven steel fiber and Kevlar material and laminated in a flexible plastic high strength ABS polymer material.

11. A method of detecting a position, comprising:
detecting an electro-mechanical latch retaining device holding said band on said user wrist, by detecting an electrical state indicative of whether said latch retaining is opened or closed;
activating said latch retaining device to hold said band around a wrist of a user;
communicating information from a body that is attached to said band, to a remote device;
in said body, during a monitoring mode, detecting a position and sending information to said remote device indicative of said position, and also sending information indicative of whether said locking mechanism is opened or closed, and whether a control has been pressed to open said latch, and receiving information from said remote device indicative of a command to lock said electronic locking mechanism.

12. A method as in claim 11, further comprising obtaining visual digital pictures and transmitting data indicative thereof to the remote monitoring method.

13. The method as in claim 11, further comprising using a same control to open said latch retaining device, and also to create a ‘Panic Button’ during a monitoring mode.

14. The method as in claim 11, wherein said detecting a position comprises monitoring a satellite positioning system.

15. The method as in claim 11, wherein said detecting a position comprises mobile phone G3 and G4 triangulation of wireless signals.

16. The method as in claim 14, wherein said electronic assembly automatically causes locking when no positioning signals are received.

17. The method as in claim 12, further comprising concealing said camera.

18. The method as in claim 12, wherein said camera is activated by triggering, and responsive to said triggering to transmit digital picture files to a remote monitoring device at periodic intervals.

19. The method as in claim 11 further comprising detecting that the band has been cut, during said monitoring mode.
